(19) United States
(12) Patent Application Publication
(10) Pub. No.: US 2020/0387110 A1
(43) Pub. Date: Dec. 10, 2020

(54) ADHESIVE-FREE PHOTOPOLYMER LAYER STRUCTURE

(71) Applicant: Covestro Deutschland AG, Leverkusen (DE)

(72) Inventors: Thomas FÄCKE, Leverkusen (DE); Therese KLOBUTOWSKI, Leverkusen (DE); Enrico ORSELLI, Münster (DE)

(73) Assignee: Covestro Deutschland AG, Leverkusen (DE)

(21) Appl. No.: 16/770,255

(22) PCT Filed: Dec. 3, 2018
(86) PCT No.: PCT/EP2018/083347

§ 371 Date: Jun. 5, 2020

(30) Foreign Application Priority Data
Dec. 6, 2017 (EP) 17205629.3

(51) Int. Cl. G03H 1/02; B32B 38/00; B32B 37/18; B32B 27/08; B32B 27/36

(52) U.S. Cl. CPC G03H 1/0256; B32B 38/0008; B32B 37/182; B32B 27/08; G03H 1/0011; B32B 2457/20; B32B 2554/00; B32B 2307/412; G03H 2260/12; B32B 27/365

(57) ABSTRACT

The invention relates to a process for producing a layer construction with adhesive-free bonding, to a layer structure comprising an exposed photopolymer layer B and a substrate layer C of (co)polycarbonate, to a sealed optical medium comprising the layer structure, and to an optical display and a security document comprising the sealed optical medium.

The invention relates to a process for producing a layer construction with adhesive-free bonding, to a layer structure comprising an exposed photopolymer layer B and a substrate layer C of (co)polycarbonate, to a sealed optical medium comprising the layer structure, and to an optical display and a security document comprising the sealed optical medium.

Photopolymer layers for producing holographic media are known in principle from WO 2011/054797 and WO 2011/067057. Advantages of these holographic media are their high light diffraction efficiency and that no reprocessing steps are needed after the holographic exposure, for example chemical or thermal development steps.

Patent application WO2013/102603 A1 discloses a layer composite composed of a photopolymer film and an adhesive layer. In the application of adhesive layers to a photopolymer layer, there is always the risk of a change in colour of the hologram in the photopolymer layer. Moreover, such bonding techniques must also permit layer constructions which ensure stability of the hologram in the photopolymer layer at elevated temperatures.

Patent application WO2017/081078 A1 describes a process for producing a layer structure, in which a sealing layer is first applied to a photopolymer layer and then cured with the aid of actinic radiation. By this process, it is possible to seal only exposed photopolymer layers since the actinic radiation used to cure the protective layer inactivates any unexposed photopolymer layer.

WO 2014/114654 A1 and DE 10 2013 200 980 A1 disclose a process for subsequent holographic inscription. The composite body used in this process consists of multiple polycarbonate layers into which an unexposed photopolymer layer has been integrated. The integration of the photopolymer layer is conducted at temperatures in the range from 120° C. to 220° C., preferably by lamination. A disadvantage is that, at such high temperatures, there can be damage to the photopolymer layer and the substrate layers of polycarbonate.

The problem addressed by the present invention was thus that of providing a sealing process for exposed and unexposed photopolymer films which produces a stable bond between the photopolymer layer and the protective layer without damaging and/or impairing the properties of the photopolymer layer or protective layer. Furthermore, for sealed photopolymer films that have been produced by the process according to the invention, no further reprocessing steps should be required after the holographic exposure.

The problem was solved by a process for producing an at least part-bonded layer construction comprising a photopolymer layer B containing a hologram, and a substrate layer C of (co)polycarbonate, characterized in that the process comprises the following steps:
a) directly contacting an unexposed photopolymer layer B or a part-exposed photopolymer layer B containing a hologram with the substrate layer C, so as to form a layer composite B-C,
b) heating the layer composite B-C to a temperature of 70° C. to 110° C.,
c) optionally exposing a hologram into the unexposed photopolymer layer B comprising matrix polymers, writing monomers, photoinitiators, optionally at least one non-photopolymerizable component and optionally catalysts, free-radical stabilizers, solvents, additives and other assistants and/or added substances,
d) subjecting the part-exposed layer composite B-C containing a hologram to actinic radiation, preferably comprising UV radiation,
   wherein step d) is always conducted as the last step. The photopolymer layer B is bonded to the substrate layer C in an adhesive-free manner in the process according to the invention.

The advantage of the process according to the invention is that it enables, in a simple manner, the sealing of a part-exposed or unexposed photopolymer layer which does not require any complex machinery or particularly trained personnel, and wherein components B and C are matched to one another such that they firstly enable good adhesion and secondly ensure frequency stability/grid stability of the hologram and protection from chemical, physical and mechanical stress. In addition, the adhesive-free bonding of the substrate layer C to the photopolymer layer B achieves high compatibility, and general improved user-friendliness of the exposed or unexposed photopolymer layer, for example protection against dusting by prevention of residual tackiness or protection against chemical and physical influences.

The layer constructions produced by the process according to the invention have a high bonding force between the photopolymer layer B and the substrate layer C, such that the layer composite can be efficiently processed further, for example in an injection-moulded article, can be subjected to a further lamination step or can be applied to a cast lens. It is also possible to process the layer construction obtained both on the substrate layer A and substrate layer C by a further lamination or bonding step without affecting the hologram. Bonding steps with liquid varnishes that typically contain solvents or reactive diluents can thus now also be used without these being able to penetrate into the photopolymer layer B and hence alter the hologram.

In one embodiment of the process according to the invention, process steps a)-d) are conducted in the sequence a), b), c) and d) or in the sequence a), c), b) and d) or in the sequence c), a), b) and d), preferably in the sequence c), a), b) and d).

In one embodiment of the process of the invention, the process comprises the following steps:
a) directly contacting an unexposed photopolymer layer B with the substrate layer C, so as to form a layer composite B-C,
b) heating the layer composite B-C from step a) to a temperature of 70° C. to 110° C.,
c) exposing a hologram, preferably a volume hologram, into the unexposed photopolymer layer B of the layer composite B-C from step b), where the photopolymer layer B comprises matrix polymers, writing monomers, photoinitiators, optionally at least one non-photopolymerizable component and optionally catalysts, free-radical stabilizers, solvents, additives and other assistants and/or added substances,
d) subjecting the layer composite B-C from step c) to actinic radiation, preferably comprising UV radiation,
   wherein the steps are implemented in the sequence specified.

In one embodiment of the process of the invention, the process comprises the following steps:
a) directly contacting an unexposed photopolymer layer B with the substrate layer C, so as to form a layer composite B-C,
b) exposing a hologram, preferably a volume hologram, into the unexposed photopolymer layer B of the layer composite B-C from step a), where the photopolymer layer B comprises matrix polymers, writing monomers, photoinitiators, optionally at least one non-photopolymerizable component and optionally catalysts, free-radical stabilizers, solvents, additives and other assistants and/or added substances,
c) heating the layer composite B-C from step b) to a temperature of 70° C. to 110° C.,
d) subjecting the layer composite B-C from step c) to actinic radiation, preferably comprising UV radiation,
   wherein the steps are implemented in the sequence specified.

In one embodiment of the process of the invention, the process comprises the following steps:
a) exposing a hologram, preferably a volume hologram, into the unexposed photopolymer layer B, where the photopolymer layer B comprises matrix polymers, writing monomers, photoinitiators, optionally at least one non-photopolymerizable component and optionally catalysts, free-radical stabilizers, solvents, additives and other assistants and/or added substances,
b) directly contacting the photopolymer layer B containing a hologram from step a) with the substrate layer C, so as to form a layer composite B-C,
c) heating the layer composite B-C from step b) to a temperature of 70° C. to 110° C.,
d) subjecting the layer composite B-C from step c) to actinic radiation, preferably comprising UV radiation,
   wherein the steps are implemented in the sequence specified.

In one embodiment of the process according to the invention, the layer composite B-C is heated in step b) or the heating step for 0.2 second to 60 minutes, preferably 0.5 second to 30 minutes, to a temperature of 70° C. to 110° C., preferably to 75° C. to 110° C., more preferably to 80° C. to 110° C., even more preferably to 90° C. to 110° C.

In one embodiment of the process according to the invention, the layer composite after implementation of step b) or the heating step has a bonding force in accordance with ISO/IEC 10373 using a tensile tester according to DIN EN ISO 527-1 between the layers B and C of at least 0.5 N/10 mm, preferably of at least 0.8 N/10 mm, more preferably of 0.9 N/10 mm, even more preferably of 1.2 N/10 mm.

In another embodiment of the process according to the invention, the layer composite after implementation of step b) or the heating step has a bonding force in accordance with ISO/IEC 10373 using a tensile tester according to DIN EN ISO 527-1 between the layers B and C of at least 0.5 N/10 mm, preferably of at least 0.8 N/10 mm, more preferably of at least 0.9 N/10 mm, even more preferably of at least 1.2 N/10 mm, wherein heating has been effected at at least 70° C. for 30 seconds in the heating step.

In one embodiment of the process according to the invention, the temperature in step b) is 75° C. to 110° C., preferably 80° C. to 110° C., even more preferably 90° C. to 110° C.

In one embodiment of the process according to the invention, step b) or the heating step is conducted in a heated space, preferably an oven, or a laminator.

In one embodiment of the process according to the invention, step a) or the step of direct contacting of the photopolymer layer and the substrate layer C and step b) or the heating step are conducted in a joint step.

In one embodiment of the process according to the invention, the photopolymer layer B is present on a substrate layer A, where the layers A and B are bonded to one another in an adhesive-free manner, where the substrate layer A is preferably a transparent thermoplastic substrate layer or glass.

In one embodiment of the process according to the invention, the substrate layer C is present on a substrate layer D and is at least part-bonded thereto, preferably bonded in an adhesive-free manner, where the substrate layer D preferably consists of a transparent thermoplastic material or a material composite.

In one embodiment of the process according to the invention, the glass transition temperature T_{g} of the substrate layer C is higher than the temperature in process steps a)-d) for production of the layer composite B-C according to the invention.

Actinic radiation means electromagnetic radiation having a wavelength within the visible (400 nm to 800 nm) spectral range, and in the UV-C, UV-B and/or UV-A range. Preference is given to exposure to actinic radiation within the spectral range of the UV region, preferably in the UV-A and/or UV-B region. It is likewise preferable to combine UV and the visible region, as can typically be generated in mercury vapour lamps. It is likewise possible to produce such a mixture of visible light with white LEDs and UV light with UV LEDs (LEDs that emit 360-370 nm, for example).

In one embodiment of the process according to the invention, the substrate layer C is an aromatic polycarbonate layer, preferably an aromatic homopolycarbonate layer.

Materials or material composites of the substrate layer A are based on polycarbonate (PC), polyethylene terephthalate (PET), amorphous polyesters, polybutylene terephthalate, polyethylene, polypropylene, cellulose acetate, cellulose hydrate, cellulose nitrate, cycloolefin polymers, polystyrene, hydrogenated polystyrene, polyepoxides, polysulfone, thermoplastic polyurethane (TPU), cellulose triacetate (CTA), polyamide (PA), polymethyl methacrylate (PMMA), polyvinyl chloride, polyvinyl acetate, polyvinyl butyral or polydicyclopentadiene or mixtures thereof. They are particularly preferably based on PC, PET, PA, PMMA and CTA. Material composites may be film laminates or coextrudates. Preferred material composites are duplex and triplex films constructed according to one of the schemes A/B, A/B/A or A/B/C. Particularly preferred are PC/PMMA, PC/PA, PC/PET, PET/PC/PET and PC/TPU. It is preferable when substrate layer A is transparent in the spectral region of 400-800 nm.

The photopolymer layer B comprises matrix polymers, writing monomers and photoinitiators. Matrix polymers used may be amorphous thermoplastics, for example polyacrylates, polymethylmethacrylates or copolymers of methyl methacrylate, methacrylic acid or other alkyl acrylates and alkyl methacrylates, and also acrylic acid, for example polybutyl acrylate, and also polyvinyl acetate and polyvinyl butyrate, the partially hydrolysed derivatives thereof, such as polyvinyl alcohols, and copolymers with ethylenes and/or further (meth)acrylates, gelatins, cellulose esters and cellulose ethers such as methyl cellulose, cellulose acetobutyrate, silicones, for example polydimethylsilicone, polyurethanes, polybutadienes and polyisoprenes, and also polyethylene oxides, epoxy resins, especially aliphatic epoxy resins, polyamides, polycarbonates and the systems cited in U.S. Pat. No. 4,994,347A and therein.

It is particularly preferable, however, when the matrix polymers are polyurethanes.

It is also particularly preferable when the matrix polymers have been crosslinked. It is especially preferable when the matrix polymers have been three-dimensionally crosslinked.

Epoxy resins may be cationically intracrosslinked. In addition, it is also possible to use acids/anhydrides, amines, hydroxyalkyl amides and thiols as crosslinkers.

Silicones can be crosslinked either as one-component systems through condensation in the presence of water (and optionally under Brønsted acid catalysis) or as two-component systems by addition of silicic ester or organotin compounds. Hydrosilylation in vinyl-silane systems is also possible.

Unsaturated compounds, for example acryloyl-functional polymers or unsaturated esters, can be crosslinked with amines or thiols. Cationic vinyl ether polymerization is also possible.

However, it is especially preferable when the matrix polymers are crosslinked, preferably three-dimensionally crosslinked, and very particularly preferably are three-dimensionally crosslinked polyurethanes. Polyurethane matrix polymers are obtainable in particular by reaction of at least one polyisocyanate component a) with at least one isocyanate-reactive component b).

The polyisocyanate component a) comprises at least one organic compound having at least two NCO groups. These organic compounds may in particular be monomeric di- and triisocyanates, polyisocyanates and/or NCO-functional prepolymers. The polyisocyanate component a) may also contain or consist of mixtures of monomeric di- and triisocyanates, polyisocyanates and/or NCO-functional prepolymers.

Employable monomeric di- and triisocyanates include all of the compounds or mixtures thereof well known per se to the person skilled in the art. These compounds may have aromatic, araliphatic, aliphatic or cycloaliphatic structures. In minor amounts the monomeric di- and triisocyanates may also comprise monoisocyanates, i.e. organic compounds having one NCO group.

Examples of suitable monomeric di- and triisocyanates are butane 1,4-diisocyanate, pentane 1,5-diisocyanate, hexane 1,6-diisocyanate (hexamethylene diisocyanate, HDI), 2,2,4-trimethylhexamethylene diisocyanate and/or 2,4,4-trimethylhexamethylene diisocyanate (TMDI), isophorone diisocyanate (IPDI), 1,8-diisocyanato-4-(isocyanatomethyl)octane, bis(4,4′-isocyanatocyclohexyl)methane and/or bis(2′,4-isocyanatocyclohexyl)methane and/or mixtures thereof with any isomer content, cyclohexane 1,4-diisocyanate, the isomeric bis(isocyanatomethyl)cyclohexanes, 2,4- and/or 2,6-diisocyanato-1-methylcyclohexane (hexahydrotolylene 2,4- and/or 2,6-diisocyanate, H₆-TDI), phenylene 1,4-diisocyanate, tolylene 2,4- and/or 2,6-diisocyanate (TDI), naphthylene 1,5-diisocyanate (NDI), diphenylmethane 2,4′- and/or 4,4′-diisocyanate (MDI), 1,3-bis(isocyanatomethyl)benzene (XDI) and/or the analogous 1,4 isomer, or any desired mixtures of the aforementioned compounds.

Suitable polyisocyanates are compounds which have urethane, urea, carbodiimide, acylurea, amide, isocyanurate, allophanate, biuret, oxadiazinetrione, uretdione and/or iminooxadiazinedione structures and are obtainable from the aforementioned di- or triisocyanates.

It is particularly preferable when the polyisocyanates are oligomerized aliphatic and/or cycloaliphatic di- or triisocyanates, the abovementioned aliphatic and/or cycloaliphatic di- or triisocyanates in particular being employable.

Very particular preference is given to polyisocyanates having isocyanurate, uretdione and/or iminooxadiazinedione structures and also to biurets based on HDI or mixtures thereof.

Suitable prepolymers contain urethane and/or urea groups, and optionally further structures formed through modification of NCO groups as recited above. Prepolymers of this kind are obtainable, for example, by reaction of the abovementioned monomeric di- and triisocyanates and/or polyisocyanates a1) with isocyanate-reactive compounds b1).

Employable isocyanate-reactive compounds b1) include alcohols or amino or mercapto compounds, preferably alcohols. These may in particular be polyols. Very particularly preferably employable as isocyanate-reactive compound b1) are polyester polyols, polyether polyols, polycarbonate polyols, poly(meth)acrylate polyols and/or polyurethane polyols.

Suitable polyester polyols are, for example, linear polyester diols or branched polyester polyols which can be obtained in a known manner by reacting aliphatic, cycloaliphatic or aromatic di- or polycarboxylic acids or the anhydrides thereof with polyhydric alcohols of OH functionality ≥2. Examples of suitable di- or polycarboxylic acids are polybasic carboxylic acids such as succinic acid, adipic acid, suberic acid, sebacic acid, decanedicarboxylic acid, phthalic acid, terephthalic acid, isophthalic acid, tetrahydrophthalic acid or trimellitic acid, and acid anhydrides such as phthalic anhydride, trimellitic anhydride or succinic anhydride, or any desired mixtures thereof. The polyester polyols may also be based on natural raw materials such as castor oil. It is likewise possible that the polyester polyols are based on homo- or copolymers of lactones which are preferably obtainable by addition of lactones or lactone mixtures such as butyrolactone, ε-caprolactone and/or methyl-ε-caprolactone onto hydroxy-functional compounds such as polyhydric alcohols of OH functionality ≥2, for example of the kind recited below.

Examples of suitable alcohols are all polyhydric alcohols, for example the C₂-C₁₂ diols, the isomeric cyclohexanediols, glycerol or any desired mixtures thereof.

Suitable polycarbonate polyols are obtainable in a manner known per se by reacting organic carbonates or phosgene with diols or diol mixtures.

Suitable organic carbonates are dimethyl carbonate, diethyl carbonate and diphenyl carbonate.

Suitable diols or mixtures comprise the polyhydric alcohols of OH functionality ≥2 mentioned per se in the context of the polyester segments, preferably butane-1,4-diol, hexane-1,6-diol and/or 3-methylpentanediol. It is also possible to convert polyester polyols to polycarbonate polyols.

Suitable polyether polyols are polyaddition products, optionally of blockwise construction, of cyclic ethers onto OH- or NH-functional starter molecules.

Suitable cyclic ethers are, for example, styrene oxides, ethylene oxide, propylene oxide, tetrahydrofuran, butylene oxide, epichlorohydrin and any desired mixtures thereof.

Starters used may be the polyhydric alcohols of OH functionality ≥2 mentioned per se in the context of the polyester polyols, and also primary or secondary amines and amino alcohols.

Preferred polyether polyols are those of the aforementioned type based exclusively on propylene oxide, or random or block copolymers based on propylene oxide with further 1-alkylene oxides.

Particular preference is given to propylene oxide homopolymers and random or block copolymers having oxyethylene, oxypropylene and/or oxybutylene units, where the proportion of the oxypropylene units based on the total amount of all oxyethylene, oxypropylene and oxybutylene units makes up at least 20% by weight, preferably at least 45% by weight. Oxypropylene and oxybutylene here include all respective linear and branched C₃ and C₄ isomers.

In addition, suitable constituents of the polyol component b1), as polyfunctional isocyanate-reactive compounds, are also aliphatic, araliphatic or cycloaliphatic di-, tri- or polyfunctional alcohols of low molecular weight, i.e. having molecular weights of ≤500 g/mol, and having short chains, i.e. containing 2 to 20 carbon atoms.

These may be, for example, in addition to the abovementioned compounds, neopentyl glycol, 2-ethyl-2-butylpropanediol, trimethylpentanediol, positionally isomeric diethyloctanediols, cyclohexanediol, cyclohexane-1,4-dimethanol, hexane-1,6-diol, cyclohexane-1,2- and -1,4-diol, hydrogenated bisphenol A, 2,2-bis(4-hydroxycyclohexyl)propane or 2,2-dimethyl-3-hydroxypropionic acid, 2,2-dimethyl-3-hydroxypropyl esters. Examples of suitable triols are trimethylolethane, trimethylolpropane or glycerol. Suitable higher-functionality alcohols are di(trimethylolpropane), pentaerythritol, dipentaerythritol or sorbitol.

It is particularly preferred when the polyol component is a difunctional polyether or polyester or a polyether-polyester block copolyester or a polyether-polyester block copolymer with primary OH functions.

It is likewise possible to use amines as isocyanate-reactive compounds b1). Examples of suitable amines are ethylenediamine, propylenediamine, diaminocyclohexane, 4,4′-dicyclohexylmethanediamine, isophoronediamine (IPDA), difunctional polyamines, for example the Jeffamines®, amine-terminated polymers, in particular having number-average molar masses ≤10 000 g/mol. Mixtures of the aforementioned amines may likewise be used.

It is likewise possible to use amino alcohols as isocyanate-reactive compounds b1). Examples of suitable amino alcohols are the isomeric aminoethanols, the isomeric aminopropanols, the isomeric aminobutanols and the isomeric aminohexanols or any desired mixtures thereof.

All the aforementioned isocyanate-reactive compounds b1) can be mixed with one another as desired.

It is also preferable when the isocyanate-reactive compounds b1) have a number-average molar mass of ≥200 and ≤10 000 g/mol, more preferably ≥500 and ≤8000 g/mol and very particularly preferably ≥800 and ≤5000 g/mol. The OH functionality of the polyols is preferably 1.5 to 6.0, particularly preferably 1.8 to 4.0.

The prepolymers of the polyisocyanate component a) may in particular have a residual content of free monomeric di- and triisocyanates of ≤1% by weight, particularly preferably ≤0.5% by weight and very particularly preferably ≤0.3% by weight.

It may also be possible for the polyisocyanate component a) to contain, in full or in part, an organic compound wherein the NCO groups have been fully or partly reacted with blocking agents known from coating technology. Examples of blocking agents are alcohols, lactams, oximes, malonic esters, pyrazoles, and amines, for example butanone oxime, diisopropylamine, diethyl malonate, ethyl acetoacetate, 3,5-dimethylpyrazole, ε-caprolactam, or mixtures thereof.

It is particularly preferable when the polyisocyanate component a) comprises compounds having aliphatically bonded NCO groups, where aliphatically bonded NCO groups are understood to mean those groups bonded to a primary carbon atom. The isocyanate-reactive component b) preferably comprises at least one organic compound having on average at least 1.5 and preferably 2 to 3 isocyanate-reactive groups. In the context of the present invention, isocyanate-reactive groups are preferably considered to be hydroxyl, amino or mercapto groups.

The isocyanate-reactive component may in particular comprise compounds having a number average of at least 1.5 and preferably 2 to 3 isocyanate-reactive groups.

Suitable polyfunctional isocyanate-reactive compounds of component b) are for example the above-described compounds 1)1).

It is also most preferable when the polyurethanes are based on polyester C4 polyether polyols.

Photoinitiators of the component are compounds activatable typically by means of actinic radiation, which can trigger polymerization of the writing monomers. The photoinitiators can be distinguished between unimolecular (type I) and bimolecular (type II) initiators. In addition, they are distinguished by their chemical nature in photoinitiators for free-radical, anionic, cationic or mixed types of polymerization.

Type I photoinitiators (Norrish type I) for free-radical photopolymerization on irradiation form free radicals through unimolecular bond scission. Examples of type I photoinitiators are triazines, oximes, benzoin ethers, benzil ketals, bisimidazoles, aroylphosphine oxides, sulfonium salts and iodonium salts.

Type II photoinitiators (Norrish type II) for free-radical polymerization consist of a dye sensitizer and a coinitiator, and undergo a bimolecular reaction on irradiation with light attuned to the dye. The dye at first absorbs a photon and transmits energy to the coinitiator from an excited state. The latter releases the polymerization-initiating free radicals through electron or proton transfer or direct hydrogen abstraction.

In the context of the present invention, preference is given to using type II photoinitiators.

Such photoinitiator systems are described in principle in EP 0 223 587 A and preferably consist of a mixture of one or more dyes with ammonium alkylarylborate(s).

Suitable dyes which, together with an ammonium alkylarylborate, form a type II photoinitiator are the cationic dyes described in WO 2012062655 in combination with the anions likewise described therein.

Cationic dyes are preferably understood to mean those of the following classes: acridine dyes, xanthene dyes, thioxanthene dyes, phenazine dyes, phenoxazine dyes, phenothiazine dyes, tri(het)arylmethane dyes—especially diamino- and triamino(het)arylmethane dyes, mono-, di-, tri- and pentamethinecyanine dyes, hemicyanine dyes, externally cationic merocyanine dyes, externally cationic neutrocyanine dyes, zeromethine dyes—especially naphtholactam dyes, streptocyanine dyes. Dyes of this kind are described, for example, in H. Berneth in Ullmann's Encyclopedia of Industrial Chemistry, Azine Dyes, Wiley-VCH Verlag, 2008, H. Berneth in Ullmann's Encyclopedia of Industrial Chemistry, Methine Dyes and Pigments, Wiley-VCH Verlag, 2008, T. Gessner, U. Mayer in Ullmann's Encyclopedia of Industrial Chemistry, Triarylmethane and Diarylmethane Dyes, Wiley-VCH Verlag, 2000.

Particular preference is given to phenazine dyes, phenoxazine dyes, phenothiazine dyes, tri(het)arylmethane dyes—especially diamino- and triamino(het)arylmethane dyes, mono-, di-, tri- and pentamethinecyanine dyes, hemicyanine dyes, zeromethine dyes—especially naphtholactam dyes, streptocyanine dyes.

Examples of cationic dyes are Astrazon Orange G, Basic Blue 3, Basic Orange 22, Basic Red 13, Basic Violet 7, Methylene Blue, New Methylene Blue, Azure A, 2,4-diphenyl-6-(4-methoxyphenyl)pyrylium, Safranin O, Astraphloxin, Brilliant Green, Crystal Violet, Ethyl Violet and thionine.

Preferred anions are especially C₈- to C₂₅-alkanesulfonate, preferably C₁₃- to C₂₅-alkanesulfonate, C₃- to C₁₈-perfluoroalkanesulfonate, C4- to C₁₈-perfluoroalkanesulfonate bearing at least 3 hydrogen atoms in the alkyl chain, C₉- to C₂₅-alkanoate, C₉- to C₂₅-alkenoate, C₈- to C₂₅-alkylsulfate, preferably C₁₃- to C25-alkylsulfate, C8- to C25-alkenylsulfate, preferably C₁₃- to C25-alkenylsulfate, C₃- to C₁₈-perfluoroalkylsulfate, C4- to C₁₈-perfluoroalkylsulfate bearing at least 3 hydrogen atoms in the alkyl chain, polyether sulfates based on at least 4 equivalents of ethylene oxide and/or 4 equivalents of propylene oxide, bis-C₄- to C₂₅-alkyl sulfosuccinate, C₅- to C₇-cycloalkyl sulfosuccinate, C₃- to C₈-alkenyl sulfosuccinate or C₇- to C₁₁-aralkyl sulfosuccinate, bis-C₂- to C₁₀-alkyl sulfosuccinate substituted by at least 8 fluorine atoms, C₈- to C₂₅-alkyl sulfoacetates, benzenesulfonate substituted by at least one radical from the group of halogen, C₄- to C₂₅-alkyl, perfluoro-C₁- to C₈-alkyl and/or C₁- to C₁₂-alkoxycarbonyl, naphthalene- or biphenylsulfonate optionally substituted by nitro, cyano, hydroxyl, C₁- to C₂₅-alkyl, C₁- to C₁₂-alkoxy, amino, C₁- to C₁₂-alkoxycarbonyl or chlorine, benzene-, naphthalene- or biphenyldisulfonate optionally substituted by nitro, cyano, hydroxyl, C₁- to C25-alkyl, C₁- to C₁₂-alkoxy, C₁- to C₁₂-alkoxycarbonyl or chlorine, benzoate substituted by dinitro, C₆- to C₂₅-alkyl, C₄- to C₁₂-alkoxycarbonyl, benzoyl, chlorobenzoyl or tolyl, the anion of naphthalenedicarboxylic acid, diphenyl ether disulfonate, sulfonated or sulfated, optionally at least monounsaturated C₈ to C₂₅ fatty acid esters of aliphatic C₁ to C₈ alcohols or glycerol, bis(sulfo-C₂- to C₆-alkyl) C₃- to C₁₂-alkanedicarboxylates, bis(sulfo-C₂- to C₆-alkyl) itaconates, (sulfo-C₂- to C₆-alkyl) C₆- to C₁₈-alkanecarboxylates, sulfo-C₂- to C₆-alkyl acrylates or methacrylates, triscatechol phosphate optionally substituted by up to 12 halogen radicals, an anion from the group of tetraphenylborate, cyanotriphenylborate, tetraphenoxyborate, C₄- to C₁₂-alkyl-triphenylborate, the phenyl or phenoxy radicals of which may be substituted by halogen, C₁- to C₄-alkyl and/or C₁- to C₄-alkoxy, C₄- to C₁₂-alkyl trinaphthylborate, tetra-C₁- to C₂₀-alkoxyborate, 7,8- or 7,9-dicarbanidoundecaborate(1-) or (2-), optionally substituted on the boron and/or carbon atoms by one or two C₁- to Cu₁₂-alkyl or phenyl groups, dodecahydrodicarbadodecaborate(2-) or B-C₁- to C₁₂-alkyl-C-phenyldodecahydrodicarbadodecaborate(1-), where, in the case of polyvalent anions such as naphthalenedisulfonate, A⁻ is one equivalent of this anion, and where the alkane and alkyl groups may be branched and/or substituted by halogen, cyano, methoxy, ethoxy, methoxycarbonyl or ethoxycarbonyl.

It is also preferable when the anion A⁻ of the dye has an AClogP in the range from 1 to 30, more preferably in the range from 1 to 12 and especially preferably in the range from 1 to 6.5. AClogP is computed according to J. Comput. Aid. Mol. Des. 2005, 19, 453; Virtual Computational Chemistry Laboratory, http://www.vcclab.org.

Suitable ammonium alkylarylborates are for example (Cunningham et al., RadTech'98 North America UV/EB Conference Proceedings, Chicago, Apr. 19-22, 1998): tetrabutylammonium triphenylhexylborate, tetrabutylammonium triphenylbutylborate, tetrabutylammonium trinaphthylhexylborate, tetrabutylammonium tris(4-tert-butyl)phenylbutylborate, tetrabutylammonium tris(3-fluorophenyl)hexylborate ([191726-69-9], CGI 7460, product from BASF SE, Basle, Switzerland), 1-methyl-3-octylimidazolium dipentyldiphenylborate and tetrabutylammonium tris(3-chloro-4-methylphenyl)hexylborate ([1147315-11-4], CGI 909, product from BASF SE, Basle, Switzerland).

It may be advantageous to use mixtures of these photoinitiators. According to the radiation source used, the type and concentration of photoinitiator has to be adjusted in the manner known to those skilled in the art. Further details are described, for example, in P. K. T. Oldring (Ed.), Chemistry & Technology of UV & EB Formulations For Coatings, Inks & Paints, Vol. 3, 1991, SITA Technology, London, p. 61-328.

It is very particularly preferable when the photoinitiator comprises a combination of dyes whose absorption spectra at least partly cover the spectral range from 400 to 800 nm with at least one coinitiator attuned to the dyes.

It is also preferable when at least one photoinitiator suitable for a laser light colour selected from blue, green and red is present in the photopolymer layer B.

It is also further preferable when the photopolymer layer B contains one suitable photoinitiator each for at least two laser light colours selected from blue, green and red.

Finally, it is very particularly preferable when the photopolymer layer B contains a suitable photoinitiator for each of the laser light colours blue, green and red.

Particularly high refractive index contrasts can be achieved when the photopolymer layer B comprises an acrylate- or methacrylate-functional writing monomer. Particular preference is given to monofunctional writing monomers and especially to those monofunctional urethane (meth)acrylates described in US 2010/0036013 A1.

Suitable acrylate writing monomers are in particular compounds of the general formula (I)

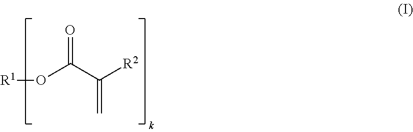

in which k≥1 and k≤4 and R¹ is a linear, branched, cyclic or heterocyclic unsubstituted or else optionally heteroatom-substituted organic radical and/or R² is hydrogen, a linear, branched, cyclic or heterocyclic unsubstituted or else optionally heteroatom-substituted organic radical. It is particularly preferable when R² is hydrogen or methyl and/or R¹ is a linear, branched, cyclic or heterocyclic unsubstituted or else optionally heteroatom-substituted organic radical.

Acrylates and methacrylates refer in the present context, respectively, to esters of acrylic acid and methacrylic acid. Examples of acrylates and methacrylates usable with preference are phenyl acrylate, phenyl methacrylate, phenoxyethyl acrylate, phenoxyethyl methacrylate, phenoxyethoxyethyl acrylate, phenoxyethoxyethyl methacrylate, phenylthioethyl acrylate, phenylthioethyl methacrylate, 2-naphthyl acrylate, 2-naphthyl methacrylate, 1,4-bis(2-thionaphthyl)-2-butyl acrylate, 1,4-bis(2-thionaphthyl)-2-butyl methacrylate, bisphenol A diacrylate, bisphenol A dimethacrylate, and the ethoxylated analogue compounds thereof, N-carbazolyl acrylates.

Urethane acrylates are understood in the present context to mean compounds having at least one acrylic ester group and at least one urethane bond. Such compounds can be obtained, for example, by reacting a hydroxy-functional acrylate or methacrylate with an isocyanate-functional compound.

Examples of isocyanate-functional compounds usable for this purpose are monoisocyanates, and the monomeric diisocyanates, triisocyanates and/or polyisocyanates mentioned under a). Examples of suitable monoisocyanates are phenyl isocyanate, the isomeric methylthiophenyl isocyanates. Di-, tri- or polyisocyanates are mentioned above, as are triphenylmethane 4,4′,4″-triisocyanate and tris(p-isocyanatophenyl) thiophosphate or derivatives thereof having a urethane, urea, carbodiimide, acylurea, isocyanurate, allophanate, biuret, oxadiazinetrione, uretdione or iminooxadiazinedione structure and mixtures thereof. Preference is given here to aromatic di-, tri- or polyisocyanates.

Contemplated hydroxy-functional acrylates or methacrylates for the production of urethane acrylates include, for example, compounds such as 2-hydroxyethyl (meth)acrylate, polyethylene oxide mono(meth)acrylates, polypropylene oxide mono(meth)acrylates, polyalkylene oxide mono(meth)acrylates, poly(ε-caprolactone) mono(meth)acrylates, for example Tone° M100 (Dow, Schwalbach, Del.), 2-hydroxypropyl (meth)acrylate, 4-hydroxybutyl (meth)acrylate, 3-hydroxy-2,2-dimethylpropyl(meth)acrylate, hydroxypropyl (meth)acrylate, 2-hydroxy-3-phenoxypropyl acrylate, the hydroxy-functional mono-, di- or tetraacrylates of polyhydric alcohols such as trimethylolpropane, glycerol, pentaerythritol, dipentaerythritol, ethoxylated, propoxylated or alkoxylated trimethylolpropane, glycerol, pentaerythritol, dipentaerythritol or the technical grade mixtures thereof. Preference is given to 2-hydroxyethyl acrylate, hydroxypropyl acrylate, 4-hydroxybutyl acrylate and poly(ε-caprolactone) mono(meth)acrylate.

It is likewise possible to use the known-per-se hydroxyl-containing epoxy (meth)acrylates having OH contents of 20 to 300 mg KOH/g or hydroxyl-containing polyurethane (meth)acrylates having OH contents of 20 to 300 mg KOH/g or acrylated polyacrylates having OH contents of 20 to 300 mg KOH/g and mixtures of these with one another, and mixtures with hydroxyl-containing unsaturated polyesters and mixtures with polyester (meth)acrylates or mixtures of hydroxyl-containing unsaturated polyesters with polyester (meth)acrylates.

Preference is given especially to urethane acrylates obtainable from the reaction of tris(p-isocyanatophenyl) thiophosphate and/or m-methylthiophenyl isocyanate and/or o-phenylthiophenyl acrylate and/or o-biphenyl acrylate with alcohol-functional acrylates such as hydroxyethyl (meth)acrylate, hydroxypropyl (meth)acrylate and/or hydroxybutyl (meth)acrylate.

It is likewise possible that the writing monomer comprises or consists of further unsaturated compounds such as α,β-unsaturated carboxylic acid derivatives, for example maleates, fumarates, maleimides, acrylamides, and also vinyl ethers, propenyl ethers, allyl ethers and compounds that contain dicyclopentadienyl units, and also olefinically unsaturated compounds, for example styrene, α-methylstyrene, vinyltoluene and/or olefins.

In a further preferred embodiment, the photopolymer additionally comprises monomeric fluorourethanes.

It is particularly preferable when the fluorourethanes comprise or consist of at least one compound of the formula (II)

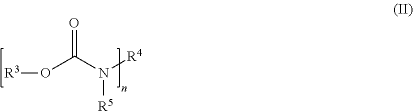

in which n≥1 and n≤8 and R³, R⁴, R⁵ are each independently hydrogen or linear, branched, cyclic or heterocyclic organic radicals which are unsubstituted or else optionally substituted by heteroatoms, where preferably at least one of the R³, R⁴, R⁵ radicals is substituted by at least one fluorine atom and, more preferably, R³ is an organic radical having at least one fluorine atom.

In a further preferred embodiment of the invention, the photopolymer contains 10% to 89.999% by weight, preferably 20% to 70% by weight, of matrix polymers, 3% to 60% by weight, preferably 10% to 50% by weight, of writing monomers, 0.001% to 5% by weight, preferably 0.5% to 3% by weight, of photoinitiators and optionally 0% to 4% by weight, preferably 0% to 2% by weight, of catalysts, 0% to 5% by weight, preferably 0.001% to 1% by weight, of stabilizers, 0% to 40% by weight, preferably 10% to 30% by weight, of monomeric fluorourethanes and 0% to 5% by weight, preferably 0.1% to 5% by weight, of further additives, wherein the sum of all constituents is 100% by weight.

Particular preference is given to using photopolymers comprising 20% to 70% by weight of matrix polymers, 20% to 50% by weight of writing monomers, 0.001% to 5% by weight of photoinitiators, 0% to 2% by weight of catalysts, 0.001% to 1% by weight of free-radical stabilizers, optionally 10% to 30% by weight of fluorourethanes and optionally 0.1% to 5% by weight of further additives.

Employable catalysts include urethanization catalysts, for example organic or inorganic derivatives of bismuth, of tin, of zinc or of iron (see also the compounds specified in US 2012/062658). Particularly preferred catalysts are butyltin tris(2-ethylhexanoate), iron(III) trisacetylacetonate, bis-muth(III) tris(2-ethylhexanoate) and tin(II) bis(2-ethylhexanoate). In addition, it is also possible to use sterically hindered amines as catalysts.

Stabilizers used may be free-radical inhibitors such as HALS amines, N-alkyl HALS, N-alkoxy HALS and N-alkoxyethyl HALS compounds, and also antioxidants and/or UV absorbers.

Employable further additives include flow control agents and/or antistats and/or thixotropic agents and/or thickeners and/or biocides.

The photopolymer layer B is especially one having, after exposure to UV radiation, a mechanical modulus G_{UV} in the range between 0.1 and 160 MPa. More particularly, the exposed holographic media may have a modulus Guy in the range between 0.3 and 40 MPa, preferably between 0.7 and 15 MPa.

The substrate layer C comprises (co)polycarbonates, especially aromatic polycarbonates or copoly-carbonates are particularly suitable in preferred embodiments. The polycarbonates or copolycarbonates may be linear or branched in known fashion. In another embodiment, the substrate layer C may be a material composite such as a film laminate or coextrudate consisting of (co)polycarbonate on one side. When a (co)polycarbonate film laminate or coextrudate is used in the process according to the invention, the side of the substrate layer C facing the photopolymer layer B is always the (co)polycarbonate side. Preferred material composites are duplex and triplex films constructed according to one of the schemes A/B, A/B/A or A/B/C. Particularly preferred are PC/PMMA, PC/PA, PC/PET and PC/TPU. The (co)polycarbonate of the substrate layer C may be untreated (native) or may have been pretreated, for example by a flame, corona, plasma and/or UV treatment.

It is preferable when substrate layer C is transparent in the spectral range of 400-800 nm.

These polycarbonates may be produced in known fashion from dihydroxyaryl compounds, carbonic acid derivatives and optionally chain terminators and branching agents. Details of the production of polycarbonates have been set out in many patent specifications during the last approximately 40 years. Reference may be made here merely by way of example to Schnell, “Chemistry and Physics of Polycarbonates”, Polymer Reviews, Volume 9, Interscience Publishers, New York, London, Sydney 1964, to D. Freitag, U. Grigo, P. R. Müller, H. Nouvertné, BAYER AG, “Polycarbonates” in Encyclopedia of Polymer Science and Engineering, Volume 11, Second Edition, 1988, pages 648-718 and finally to Dres. U. Grigo, K. Kirchner and P. R. Müller, “Polycarbonate” [Polycarbonates] in Becker/Braun, Kunststoff-Handbuch [Plastics Handbook], volume 3/1, Polycarbonate, Polyacetale, Polyester, Celluloseester [Polycarbonates, Polyacetals, Polyesters, Cellulose Esters], Carl Hanser Verlag Munich, Vienna 1992, pages 117-299.

Suitable dihydroxyaryl compounds may, for example, be dihydroxyaryl compounds of the general formula (III)

HO-Z-OH (III)

in which Z is an aromatic radical which has 6 to 34 carbon atoms and may contain one or more optionally substituted aromatic rings and aliphatic or cycloaliphatic radicals or alkylaryls or heteroatoms as bridging elements.

Examples of suitable dihydroxyaryl compounds are: dihydroxybenzenes, dihydroxydiphenyls, bis(hydroxyphenyl)alkanes, bis(hydroxyphenyl)cycloalkanes, bis(hydroxyphenyl)aryls, bis(hydroxyphenyl) ethers, bis(hydroxyphenyl) ketones, bis(hydroxyphenyl) sulfides, bis(hydroxyphenyl) sulfones, bis(hydroxyphenyl) sulfoxides, 1,1′-bis(hydroxyphenyl)diisopropylbenzenes and the ring-alkylated and ring-halogenated compounds thereof.

These and further suitable other dihydroxyaryl compounds are described, for example, in DE-A 3 832 396, FR-A 1 561 518, in “H. Schnell, Chemistry and Physics of Polycarbonates, Interscience Publishers, New York 1964, p. 28 ff; p. 102 ff”, and in “D. G. Legrand, J. T. Bendler, Handbook of Polycarbonate Science and Technology, Marcel Dekker New York 2000, p. 72 ff.”

Preferred dihydroxyaryl compounds are, for example, resorcinol, 4,4′-dihydroxydiphenyl, bis(4-hydroxyphenyl)methane, bis(3,5-dimethyl-4-hydroxyphenyl)methane, bis(4-hydroxyphenyl)diphenylmethane, 1,1-bis(4-hydroxyphenyl)-1-phenylethane, 1,1-bis(4-hydroxyphenyl)-1-(1-naphthyl)ethane, 1,1-bis(4-hydroxyphenyl)-1-(2-naphthyl)ethane, 2,2-bis(4-hydroxyphenyl)propane, 2,2-bis(3-methyl-4-hydroxyphenyl)propane, 2,2-bis(3,5-dimethyl-4-hydroxyphenyl)propane, 2,2-bis(4-hydroxyphenyl)-1-phenylpropane, 2,2-bis(4-hydroxyphenyl)hexafluoropropane, 2,4-bis(4-hydroxyphenyl)-2-methylbutane, 2,4-bis(3,5-dimethyl-4-hydroxyphenyl)-2-methylbutane, 1,1-bis(4-hydroxyphenyl)cyclohexane, 1,1-bis(3,5-dimethyl-4-hydroxyphenyl)cyclohexane, 1,1-bis(4-hydroxyphenyl)-4-methylcyclohexane, 1,3-bis-[2-(4-hydroxyphenyl)-2-propyl]benzene, 1,1′-bis(4-hydroxyphenyl)-3-diisopropylbenzene, 1,1′-bis(4-hydroxyphenyl)-4-diisopropylbenzene, 1,3-bis-[2-(3,5-dimethyl-4-hydroxyphenyl)-2-propyl]benzene, bis(4-hydroxyphenyl)ether, bis(4-hydroxyphenyl)sulfide, bis(4-hydroxyphenyl)sulfone, bis(3,5-dimethyl-4-hydroxyphenyl)sulfone and 2,2′,3,3′-tetrahydro-3,3,3′,3′-tetramethyl-1,1′-spirobi[1H-indene]-5,5′-diol or dihydroxydiphenylcycloalkanes of the formula (IIIa)

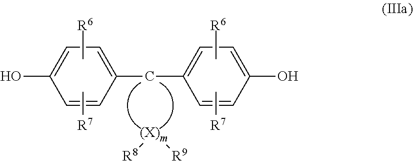

in which
R⁶ and R⁷ are independently hydrogen, halogen, preferably chlorine or bromine, C₁-C₈-alkyl, C₅-C₆-cycloalkyl, C₆-C₁₀-aryl, preferably phenyl, and C₇-C₁₂-aralkyl, preferably phenyl-C₁-C₄-alkyl, especially benzyl,
m is an integer from 4 to 7, preferably 4 or 5,
R⁸ and R⁹ can be chosen individually for each X and are independently hydrogen or C₁-C₆-alkyl and
X is carbon,
   with the proviso that, on at least one X atom, R⁸ and R⁹ are both alkyl. Preferably, in the formula (IIIa), on one or two X atom(s), especially only on one X atom, R⁸ and R⁹ are both alkyl.

A preferred alkyl radical for the R⁸ and R⁹ radicals in formula (IIIa) is methyl. The X atoms in alpha position to the diphenyl-substituted carbon atom (C-1) are preferably non-dialkyl-substituted; by contrast, preference is given to alkyl disubstitution in beta position to C-1.

Particularly preferred dihydroxydiphenylcycloalkanes of the formula (IIIa) are those having 5 and 6 ring carbon atoms X in the cycloaliphatic radical (m=4 or 5 in formula (IIIa)), for example the dihydroxyaryl compounds of the formulae (IIIa-1) to (IIIa-3)

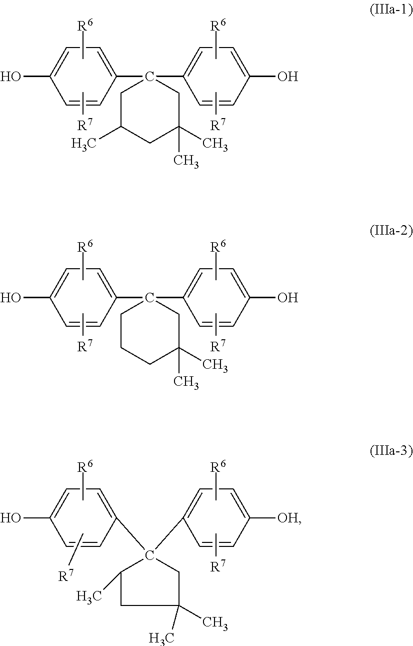

in which R⁶ and R⁷ have the definition given for formula (III).

A very particularly preferred dihydroxydiphenylcycloalkane of the formula (IIIa) is 1,1-bis(4-hydroxyphenyl)-3,3,5-trimethylcyclohexane (Formula (IIIa-1) with R⁶ and R⁷=H).

Polycarbonates of this kind can be prepared according to EP-A 359 953 from dihydroxydiphenylcycloalkanes of the formula (IIIa).

Particularly preferred dihydroxyaryl compounds are resorcinol, 4,4′-dihydroxydiphenyl, bis(4-hydroxyphenyl)diphenylmethane, 1,1-bis(4-hydroxyphenyl)-1-phenylethane, bis(4-hydroxyphenyl)-1-(1-naphthyl)ethane, bis(4-hydroxyphenyl)-1-(2-naphthyl)ethane, 2,2-bis(4-hydroxyphenyl)propane, 2,2-bis(3,5-dimethyl-4-hydroxyphenyl)propane, 1,1-bis(4-hydroxyphenyl)cyclohexane, 1,1-bis(3,5-dimethyl-4-hydroxyphenyl)cyclohexane, 1,1-bis(4-hydroxyphenyl)-3,3,5-trimethylcyclohexane, 1,1′-bis(4-hydroxyphenyl)-3-diisopropylbenzene and 1,1′-bis(4-hydroxyphenyl)-4-diisopropylbenzene.

Very particularly preferred dihydroxyaryl compounds are 2,2-bis(4-hydroxyphenyl)propane (BP-A) and 1,1-bis(4-hydroxyphenyl)-3,3,5-trimethylcyclohexane (BP-TMC).

It is possible to use either one dihydroxyaryl compound to form homopolycarbonates or various dihydroxyaryl compounds to form copolycarbonates. It is possible to use either one dihydroxyaryl compound of the formula (III) or (IIIa) to form homopolycarbonates or multiple dihydroxyaryl compounds of the formula (III) and/or (IIIa) to form copolycarbonates. The various dihydroxyaryl compounds may be joined to one another either randomly or in blocks. In the case of copolycarbonates formed from dihydroxyaryl compounds of the formula (III) and (IIIa), the molar ratio of dihydroxyaryl compounds of the formula (IIIa) to any other dihydroxyaryl compounds of the formula (III) to be used as well is preferably between 99 mol % of (IIIa) to 1 mol % of (III) and 2 mol % of (IIIa) to 98 mol % of (III), preferably between 99 mol % of (IIIa) to 1 mol % of (I) and 10 mol % (IIIa) to 90 mol % of (III), and especially between 99 mol % of (IIIa) to 1 mol % of (III) and 30 mol % of (IIIa) to 70 mol % of (III).

A very particularly preferred copolycarbonate can be prepared using 1,1-bis(4-hydroxyphenyl)-3,3,5-trimethylcyclohexane and 2,2-bis(4-hydroxyphenyl)propane as dihydroxyaryl compounds of the formulae (IIIa) and (III).

Suitable carbonic acid derivatives may, for example, be diaryl carbonates of the general formula (IV)

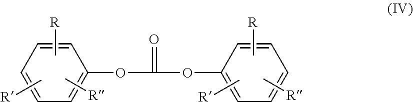

in which
R, R′ and R″ are independently the same or different and are hydrogen, linear or branched C₁-C₃₄-alkyl, C₇-C₃₄-alkylaryl or C₆-C₃₄-aryl, R may additionally also be —COO—R″ where R″ is hydrogen, linear or branched C₁-C₃₄-alkyl, C₇-C₃₄-alkylaryl or C₆-C₃₄-aryl.

Preferred diaryl carbonates are, for example, diphenyl carbonate, methylphenyl phenyl carbonates and di(methylphenyl)carbonates, 4-ethylphenyl phenyl carbonate, di(4-ethylphenyl)carbonate, 4-n-propylphenyl phenyl carbonate, di(4-n-propylphenyl)carbonate, 4-isopropylphenyl phenyl carbonate, di(4-isopropylphenyl)carbonate, 4-n-butylphenyl phenyl carbonate, di(4-n-butylphenyl)carbonate, 4-isobutylphenyl phenyl carbonate, di(4-isobutylphenyl)carbonate, 4-tert-butylphenyl phenyl carbonate, di(4-tert-butylphenyl)carbonate, 4-n-pentylphenyl phenyl carbonate, di(4-n-pentylphenyl)carbonate, 4-n-hexylphenyl phenyl carbonate, di(4-n-hexylphenyl)carbonate, 4-isooctylphenyl phenyl carbonate, di(4-isooctylphenyl)carbonate, 4-n-nonylphenyl phenyl carbonate, di(4-n-nonylphenyl)carbonate, 4-cyclohexylphenyl phenyl carbonate, di(4-cyclohexylphenyl)carbonate, 4-(1-methyl-1-phenylethyl)phenyl phenyl carbonate, di[4-(1-methyl-1-phenylethyl)phenyl]carbonate, biphenyl-4-yl phenyl carbonate, di(biphenyl-4-yl) carbonate, 4-(1-naphthyl)phenyl phenyl carbonate, 4-(2-naphthyl)phenyl phenyl carbonate, di[4-(1-naphthyl)phenyl]carbonate, di[4-(2-naphthyl)phenyl]carbonate, 4-phenoxyphenyl phenyl carbonate, di(4-phenoxyphenyl)carbonate, 3-pentadecylphenyl phenyl carbonate, di(3-pentadecylphenyl) carbonate, 4-tritylphenyl phenyl carbonate, di(4-tritylphenyl)carbonate, (methyl salicylate)phenyl carbonate, di(methyl salicylate)carbonate, (ethyl salicylate)phenyl carbonate, di(ethyl salicylate)carbonate, (n-propyl salicylate)phenyl carbonate, di(n-propyl salicylate)carbonate, (isopropyl salicylate)phenyl carbonate, di(isopropyl salicylate)carbonate, (n-butyl salicylate) phenyl carbonate, di(n-butyl salicylate)carbonate, (isobutyl salicylate)phenyl carbonate, di(isobutyl salicylate)carbonate, (tert-butyl salicylate)phenyl carbonate, di(tert-butyl salicylate) carbonate, di(phenyl salicylate)carbonate and di(benzyl salicylate)carbonate.

Particularly preferred diaryl compounds are diphenyl carbonate, 4-tert-butylphenyl phenyl carbonate, di(4-tert-butylphenyl)carbonate, biphenyl-4-yl phenyl carbonate, di(biphenyl-4-yl)carbonate, 4-(1-methyl-1-phenylethyl)phenyl phenyl carbonate, di[4-(1-methyl-1-phenylethyl)phenyl]carbonate and di(methyl salicylate)carbonate.

Very particular preference is given to diphenyl carbonate.

It is possible to use either one diaryl carbonate or various diaryl carbonates.

For control or variation of the end groups, it is additionally possible to use, for example, one or more monohydroxyaryl compound(s) as chain terminators that were not used for preparation of the diaryl carbonate(s) used. These may be those of the general formula (V)

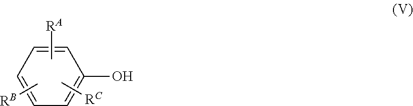

where
R^{A} is linear or branched C₁-C₃₄-alkyl, C₇-C₃₄-alkylaryl, C₆-C₃₄-aryl or —COO—R^{D} where R^{D} is hydrogen, linear or branched C₁-C₃₄-alkyl, C₇-C₃₄-alkylaryl or C₆-C₃₄-aryl, and
R^{B}, R^{C} are independently the same or different and are hydrogen, linear or branched C₁-C₃₄-alkyl, C₇-C₃₄-alkylaryl or C₆-C₃₄-aryl.

Such monohydroxyaryl compounds are, for example, 1-, 2- or 3-methylphenol, 2,4-dimethylphenol 4-ethylphenol, 4-n-propylphenol, 4-isopropylphenol, 4-n-butylphenol, 4-isobutylphenol, 4-tertbutylphenol, 4-n-pentylphenol, 4-n-hexylphenol, 4-isooctylphenol, 4-n-nonylphenol, 3-pentadecylphenol, 4-cyclohexylphenol, 4-(1-methyl-1-phenylethyl)phenol, 4-phenylphenol, 4-phenoxyphenol, 4-(1-naphthyl)phenol, 4-(2-naphthyl)phenol, 4-tritylphenol, methyl salicylate, ethyl salicylate, n-propyl salicylate, isopropyl salicylate, n-butyl salicylate, isobutyl salicylate, tert-butyl salicylate, phenyl salicylate and benzyl salicylate.

Preference is given to 4-tert-butylphenol, 4-isooctylphenol and 3-pentadecylphenol.

Suitable branching agents may be compounds having three or more functional groups, preferably those having three or more hydroxyl groups.

Suitable compounds having three or more phenolic hydroxyl groups are, for example, phloroglucinol, 4,6-dimethyl-2,4,6-tri(4-hydroxyphenyl)hept-2-ene, 4,6-dimethyl-2,4,6-tri(4-hydroxyphenyl)heptane, 1,3,5-tri(4-hydroxyphenyl)benzene, 1,1,1-tri(4-hydroxyphenyl)ethane, tri(4-hydroxyphenyl)phenylmethane, 2,2-bis(4,4-bis(4-hydroxyphenyl)cyclohexyl)propane, 2,4-bis(4-hydroxyphenylisopropyl)phenol and tetra(4-hydroxyphenyl)methane.

Other suitable compounds having three or more functional groups are, for example, 2,4-dihydroxybenzoic acid, trimesic acid/trimesoyl chloride, cyanuric chloride and 3,3-bis(3-methyl-4-hydroxyphenyl)-2-oxo-2,3-dihydroindole.

Preferred branching agents are 3,3-bis(3-methyl-4-hydroxyphenyl)-2-oxo-2,3-dihydroindole and 1,1,1-tri(4-hydroxyphenyl)ethane.

The substrate layer C may also consist of a mixture or a copolymer of various bisphenol units.

Very particular preference is given to polycarbonates or copolycarbonates, especially having average molecular weights Mw of 500 to 100 000, preferably of 10 000 to 80 000, more preferably of 15 000 to 40 000, or blends comprising at least one such polycarbonate or copolycarbonate.

Suitable blends are blends of polycarbonate or copolycarbonate with acrylonitrile-butadiene-styrene copolymers (ABS), polycarbonate or copolycarbonate with polyester(s), for example polyalkylene terephthalate, especially polyethylene terephthalate and polybutylene terephthalate, polycarbonate or copolycarbonate with vinyl (co)polymers such as polystyrene-acrylonitrile (SAN), polymethylmethacrylate (PMMA) or copolymers of two monomers, for example methyl methacrylate/styrene-acrylonitrile and methyl methacrylate/styrene. Such a blend of polycarbonate or copolycarbonate with one of the abovementioned polymeric blend partners may preferably be one having 1% to 90% by weight of polycarbonate or copolycarbonate and 99% to 10% by weight of polymeric blend partners, preferably having 1% to 90% by weight of polycarbonate and 99% to 10% by weight of polymeric blend partners, where the proportions add up to 100% by weight. Preferably, the blend is transparent in the spectral range of 400-800 nm.

Materials or material composites of the substrate layer D are based on polycarbonate (PC), polyethylene terephthalate (PET), amorphous polyesters, polybutylene terephthalate, polyethylene, polypropylene, cellulose acetate, cellulose hydrate, cellulose nitrate, cycloolefin polymers, polystyrene, hydrogenated polystyrene, polyepoxides, polysulfone, thermoplastic polyurethane (TPU), cellulose triacetate (CTA), polyamide (PA), polymethyl methacrylate (PMMA), polyvinyl chloride, polyvinyl acetate, polyvinyl butyral or polydicyclopentadiene or mixtures thereof. They are particularly preferably based on PC, PET, PA, PMMA and CTA. Material composites may be film laminates or coextrudates. Preferred material composites are duplex and triplex films constructed according to one of the schemes A/B, A/B/A or A/B/C. Particularly preferred are PC/PMMA, PC/PA, PC/PET, PET/PC/PET and PC/TPU. It is preferable when substrate layer D is transparent in the spectral region of 400-800 nm.

The invention further provides a layer construction comprising a photopolymer layer B containing a hologram, and a substrate layer C of (co)polycarbonate obtainable or obtained by the process according to the invention. Preferably, the layer composite has a bonding force in accordance with ISO/IEC 10373 using a tensile tester according to DIN EN ISO 527-1 between the layers B and C of at least 0.5 N/10 mm, preferably of at least 0.8 N/10 mm, more preferably of at least 0.9 N/10 mm, even more preferably of at least 1.2 N/10 mm. In another embodiment, the layer composite has a bonding force in accordance with ISO/IEC 10373 using a tensile tester according to DIN EN ISO 527-1 between the layers B and C of at least 0.5 N/10 mm, preferably of at least 0.8 N/10 mm, more preferably of at least 0.9 N/10 mm, even more preferably of at least 1.2 N/10 mm, where the layer composite has been heated to at least 70° C. for 30 seconds. In a preferred embodiment, the photopolymer layer B is present on a substrate layer A, where the layers A and B are bonded to one another in an adhesive-free manner, where the substrate layer A is preferably a transparent thermoplastic substrate layer or glass. In a preferred embodiment, the substrate layer C is present on a substrate layer D and is at least part-bonded thereto, preferably bonded in an adhesive-free manner, where the substrate layer D preferably consists of a transparent thermoplastic material or a material composite. In a preferred embodiment, the substrate layer C is an aromatic polycarbonate layer, preferably an aromatic homopolycarbonate layer, especially a polycarbonate layer as defined and elucidated above.

The invention further provides a sealed holographic medium comprising a layer construction according to the invention.

The invention further provides a protected hologram or holographic optical element obtainable by the inventive process for producing an at least part-bonded construction. In one embodiment, the holographic medium contains a photopolymer layer containing a hologram or a holographic optical element and having a film thickness of 0.3 μm to 500 μm, preferably of 0.5 μm to 200 μm and particularly preferably of 1 μm to 100 μm.

In particular the hologram may be a reflection, transmission, in-line, off-axis, full-aperture transfer, white light transmission, Denisyuk, off-axis reflection or edge-lit hologram, or else a holographic stereogram, and preferably a reflection, transmission or edge-lit hologram.

Possible optical functions of the holograms (as holographically optical element) correspond to the optical functions of light elements such as lenses, mirrors, deflecting mirrors, filters, diffuser lenses, directed diffusion elements, diffraction elements, light guides, waveguides, projection lenses and/or masks. In addition, a plurality of such optical functions can be combined in such a hologram, for example such that the light is deflected in a different direction according to the incidence of light. For example, it is possible with such setups to build autostereoscopic or holographic electronic displays which allow a stereoscopic visual impression to be experienced without further aids, for example a polarizer or shutter glasses, for use in automobile head-up displays or head-mounted displays.

These optical elements frequently have a specific frequency selectivity according to how the holograms have been exposed and the dimensions of the hologram. This is important in particular when monochromatic light sources such as LEDs or laser light are used. For instance, one hologram is required per complementary colour (RGB), in order to deflect light in a frequency-selective manner and at the same time to enable full-colour displays. Therefore, in particular display setups, several holograms have to be exposed in the medium in a superposed manner

In addition the sealed holographic media according to the invention may also be used to produce holographic images or representations, for example for personal portraits, biometric representations in security documents, or generally of images or image structures for advertising, security labels, brand protection, branding, labels, design elements, decorations, illustrations, collectable cards, images and the like, and also images which can represent digital data, including in combination with the products detailed above. Holographic images may have the impression of a three-dimensional image, or else can represent image sequences, short films or a number of different objects, according to the angle from which and the light source with which (including moving light sources) etc. they are illuminated. Because of this variety of possible designs, holograms, especially volume holograms, constitute an attractive technical solution for the abovementioned application. It is also possible to use such holograms for storage of digital data, using a wide variety of different exposure methods (shift, spatial or angular multiplexing).

The invention likewise provides an optical display comprising an inventive sealed holographic medium.

Examples of such optical displays are imaging displays based on liquid crystals, organic light-emitting diodes (OLEDs), LED display panels, microelectromechanical systems (MEMS) based on diffractive light selection, electrowetting displays (E-ink) and plasma display screens. Optical displays of this kind may be autostereoscopic and/or holographic displays, transmittive and reflective projection screens, displays with switchable restricted emission characteristics for privacy filters and bidirectional multiuser screens, virtual displays, head-up displays, head-mounted displays, illumination symbols, warning lamps, signal lamps, floodlights/headlights and display panels.

The invention likewise provides autostereoscopic and/or holographic displays, projection screens, displays with switchable restricted emission characteristics for privacy filters and bidirectional multiuser screens, virtual displays, head-up displays, head-mounted displays, illumination symbols, warning lamps, signal lamps, floodlights/headlights and display panels, comprising an inventive holographic medium.

The invention still further provides a security document and a holographically optical element comprising an inventive sealed holographic medium.

In addition, the invention also provides for the use of an inventive holographic medium for production of chip cards, identity documents, 3D images, product protection labels, labels, banknotes or holographically optical elements, especially for visual displays.

### EXAMPLES

### Chemicals:

In each case, the CAS number, if known, is reported in square brackets.

Raw materials for photopolymer layer B

| | |
|---|---|
| 2-Hydroxyethyl acrylate | [818-61-1]—Sigma-Aldrich Chemie GmbH |
| | Steinheim, Germany |
| 2,6-Di-tert-butyl-4- | [128-37-0]—Merck KGaA, Darmstadt, |
| methylphenol | Germany |
| 3-(Methylthio)phenyl | [28479-19-8]—Sigma-Aldrich Chemie |
| isocyanate | GmbH Steinheim, Germany |
| Desmodur ® RFE | [141-78-6] tris(p-isocyanatophenyl) |
| | thiophosphate, 27% in ethyl acetate, product |
| | from Covestro Deutschland AG, Leverkusen, |
| | Germany |
| Dibutyltin dilaurate | [77-58-7]—Sigma-Aldrich Chemie GmbH |
| | Steinheim, Germany |
| Fomrez ® UL 28 | Momentive Performance Chemicals, Wilton, |
| | CT, USA. |
| Borchi ® Kat 22 | [85203-81-2]—OMG Borchers GmbH, |
| | Langenfeld, Germany. |
| Desmodur ® N 3900 | [28182-81-2] Covestro Deutschland AG, |
| | Leverkusen, DE, hexane diisocyanate-based |
| | polyisocyanate, proportion of |
| | iminooxadiazineclione at least 30%, NCO |
| | content: 23.5%. |
| Desmorapid ® SO | [301-10-0]—Rhein Chemie Rheinau GmbH, |
| | Mannheim, Germany |
| CGI-909 | [1147315-11-4] tetrabutyl ammonium tris (3- |
| | chloro-4-methylphenyl)(hexyl)borate, BASF |
| | SE |
| Trimethylhexamethylene | [28679-16-5]—ABCR GmbH & Co KG, |
| diisocyanate | Karlsruhe, Germany |
| 1H,1H-7H- | [335-99-9]—ABCR GmbH & Co KG, |
| Perfluoroheptan-1-ol | Karlsruhe, Germany |
| Astrazon Rosa FG 200% | [3648-36-0]—DyStar Colours Deutschland |
| | GmbH, Frankfurt am Main, Germany |
| Sodium bis(2- | [45297-26-5] Sigma-Aldrich Chemie GmbH, |
| ethylhexyl)sulfosuccinate | Steinheim, Germany |
| Polytetrahydrofuran | |
| polyether polyols | |

Additives

| | |
|---|---|
| BYK 310—leveling agent | silicone-containing surface additive from |
| | BYK Chemie GmbH, Wesel, Germany |
| Tinuvin 292—light | a sterically hindered amine from BASF SE, |
| stabilizer | Ludwigshafen, Germany. |
| Irganox 1135—antioxidant | a phenolic antioxidant from BASF SE, |
| | Ludwigshafen, Germany. |

Solvent

| | |
|---|---|
| Butyl acetate (BA) | butyl acetate from Brenntag GmbH, Miilheim |
| | an der Ruhr, Germany. |
| Methoxypropanol (MP) | 1-methoxy-2-propanol from Brenntag GmbH, |
| | Miilheim an der Ruhr, Germany. |
| MPA-EEP (M/E) | a 50:50% by weight mixture of 1-methoxy-2- |
| | propyl acetate (DOWANOL ™ PMA |
| | GLYCOL ETHER ACETATE) from DOW |
| | Deutschland Anlagengesellschaft mbH, |
| | Schwalbach, Germany, and ethyl 3- |
| | ethoxypropionate from Brenntag GmbH, |
| | Miilheim an der Ruhr, Germany. |

Films

| | |
|---|---|
| Makrofol DE 1-1 | a bisphenol A (BP-A-PC)-based |
| | polycarbonate film from Covestro |
| | Deutschland AG, Leverkusen, DE, with a |
| | smooth surface on the front and reverse sides. |
| Bayfol OX503 | a bisphenol A (BP-A-PC)-based |
| | polycarbonate film from Covestro |
| | Deutschland AG, Leverkusen, DE, with a |
| | smooth surface on the front and reverse sides. |
| Hostaphan | polyethylene glycol terephtalate (PET) film |
| | from Mitsubishi Chemical Europe GmbH, |
| | Dusseldorf, Germany. |
| Tacphan | cellulose triacetate (TAC) film from LOFO |
| | High Tech Film GmbH, Weil am Rhein, |
| | Germany. |
| Transphan | polyamide (PA) film from LOFO High Tech |
| | Film GmbH, Weil am Rhein, Germany. |
| Pokalon | polycarbonate (PC) film from LOFO High |
| | Tech Film GmbH, Weil am Rhein, Germany. |
| Plexiglas | polymethylmethacrylat (PMMA) sheet from |
| | Evonik Industries AG, Essen, Germany. |

Urethane acrylate 1: Phosphorothioyltris(oxybenzene-4,1-diylcarbamoyloxyethane-2,1-diyl)trisacrylate

A 500 ml round-bottom flask was initially charged with 0.1 g of 2,6-di-tert-butyl-4-methylphenol, 0.05 g of dibutyltin dilaurate and 213.1 g of a 27% solution of tris(p-isocyanatophenyl)thiophosphate in ethyl acetate (Desmodur® RFE, product from Covestro Deutschland AG, Leverkusen, Germany), which were heated to 60° C. Subsequently, 42.4 g of 2-hydroxyethyl acrylate were added dropwise and the mixture was still kept at 60° C. until the isocyanate content had fallen below 0.1%. This was followed by cooling and complete removal of the ethyl acetate under reduced pressure. The product was obtained as a partly crystalline solid.

Urethane acrylate 2: 2-({[3-(Methylsulphanyl)phenyl]carbamoyl}oxy)ethyl prop-2-enoate

A 100 ml round-bottom flask was initially charged with 0.02 g of 2,6-di-tert-butyl-4-methylphenol, 0.01 g of dibutyltin dilaurate, 11.7 g of 3-(methylthio)phenyl isocyanate, and the mixture was heated to 60° C. Subsequently, 8.2 g of 2-hydroxyethyl acrylate were added dropwise and the mixture was still kept at 60° C. until the isocyanate content had fallen below 0.1%. This was followed by cooling. The product was obtained as a colourless liquid.

### Polyol Component:

A 1 l flask was initially charged with 0.037 g of Desmorapid® SO, 374.8 g of ε-caprolactone and 374.8 g of a difunctional polytetrahydrofuran polyether polyol, which were heated to 120° C. and kept at this temperature until the solids content (proportion of nonvolatile constituents) was 99.5% by weight or higher. Subsequently, the mixture was cooled and the product was obtained as a waxy solid.

### Dye 1:

5.84 g of anhydrous sodium bis(2-ethylhexyl)sulfosuccinate were dissolved in 75 ml of ethyl acetate. 14.5 g of the dye Astrazon Rosa FG 200%, dissolved in 50 ml of water, were added. The aqueous phase was removed and the organic phase was stirred three times with 50 ml of fresh water at 50° C. and the aqueous phase was removed each time, the last time at room temperature. After the aqueous phase had been removed, the solvent was distilled off under reduced pressure and 8.6 g of 3H-indolium, 2-[2-[4-[(2-chloroethyl)methylamino]phenyl]ethenyl]-1,3,3-trimethyl-1,4-bis(2-ethylhexyl)sulfosuccinate [153952-28-4] were obtained as an oil of high viscosity.

Fluorinated urethane: bis(2,2,3,3,4,4,5,5,6,6,7,7-Dodecafluoroheptyl)-(2,2,4-trimethylhexane-1,6-diyl)biscarbamate

A 6 l round-bottom flask was initially charged with 0.50 g of dibutyltin dilaurate and 1200 g of trimethylhexamethylene diisocyanate, and the mixture was heated to 80° C. Subsequently, 3798 g of 1H,1H,7H-perfluoroheptan-1-ol were added dropwise and the mixture was still kept at 80° C. until the isocyanate content had fallen below 0.1%. This was followed by cooling. The product was obtained as a colourless oil.

### Production of Holographic Media (Photopolymer Film)

7.90 g of the above-described polyol component were melted and mixed with 7.65 g of the respective urethane acrylate 2, 2.57 g of the above-described urethane acrylate 1, 5.10 g of the abovedescribed fluorinated urethane, 0.91 g of CGI 909, 0.232 g of dye 1, 0.230 g of BYK 310, 0.128 g of Fomrez UL 28 and 3.789 g of ethyl acetate to obtain a clear solution. This was followed by addition of 1.50 g Desmodur® N 3900 and mixing again.

Then this solution was applied in a roll-to-roll coating system to a 66 μm-thick polycarbonate carrier film, where the product was applied by means of a coating bar in a wet film thickness of 19 pm. With a drying temperature of 85° C. and a drying time of 5 minutes, the coated film was dried and then protected with a 40 μm-thick polyethylene film. Subsequently, this film was light-tightly packaged.

### Production and Characterization of Test Holograms

Test holograms were prepared as follows: the photopolymer films were cut to the desired size in the dark and laminated with the aid of a rubber roller onto a glass plate of dimensions 50 mm×70 mm (thickness 3 mm).

The test holograms were produced using a test apparatus which produces Denisyuk reflection holograms using green (532 nm) laser radiation. The test apparatus consists of a laser source, an optical beam guide system and a holder for the glass coupons. The holder for the glass coupons is mounted at an angle of 13° relative to the beam axis. The laser source generated the radiation which, widened to about 5 cm by means of a specific optical beam path, was guided to the glass coupon in optical contact with the mirror. The holographed object was a mirror about 2 cm×2 cm in size, and so the wavefront of the mirror was reconstructed on reconstructing the hologram. All 15 examples were exposed with a green 532 nm laser (Newport Corp, Irvine, Calif., USA, cat. no. EXLSR-532-50-CDRH). A shutter was used to irradiate the recording film in a defined manner for 2 seconds.

UV Exposure/Exposure with Actinic Radiation

The samples were placed onto the conveyor belt of a UV source with the carrier layer side facing the lamp and exposed twice at a belt speed of 2.5 m/min. The UV source employed was a Fusion UV “D Bulb” No. 558434 KR 85 iron-doped Hg lamp having a total power density of 80 W/cm². The parameters corresponded to a dose of 2×2.5 J/cm² (measured with an ILT 490 Light Bug).

### Analysis of the Hologram for Frequency Shift

Because of the high efficiency of the volume hologram, this diffractive reflection can be analysed in transmission with visible light with a VIS spectrometer (USB 2000, Ocean Optics, Dunedin, Fla., USA), and it appears in the transmission spectrum as a peak with reduced transmission. The quality of the hologram can be ascertained via the evaluation of the transmission curve: The width of the peak was determined as the “full width at half maximum” (FWHM) in nanometres (nm), the depth of the peak (Tmin) was reported as 100%−Tmin in per cent (1−Tₘᵢₙ), and the region with the lowest transmission indicates the wavelength (□ₚₑₐₖ) of highest diffraction efficiency.

### Study of Adhesion in Film Composite

The cohesion of all layers of the film composite was tested and evaluated by an in-house method. This involved pulling apart the photopolymer film B and the substrate film C applied thereto by hand. The results were quantified in the following grades from full adhesion (index: 0) down to no adhesion (index: 5).
0—adhesion is so strong that the film composite cannot be separated without destruction;
1—strong adhesion, can be peeled off only with considerable use of manual force;
2—moderately strong adhesion, can be peeled off with use of manual force;
3—moderate adhesion, can be peeled off with use of low force;
4—slight adhesion, can be peeled off with use of slight force;
5—very weak or zero adhesion. Film composite has contact adhesion only.

### Noninventive Examples A-C, Inventive Example 1

A film piece of size 5 cm×7 cm of the photopolymer film was cut to size in the dark (5×7 cm) and the PE lamination was removed. Subsequently, the photopolymer surface was laminated together with a polycarbonate film (Makrofol DE 1-1, thickness 125 μm) by means of a roll laminator (Dumor Trident 46; lamination speed: 0.3 m/min, roll pressure setting: high; contact time: about 0.5 sec) at various roll temperatures. Thereafter, a reflection hologram was written at 532 nm and the sample was fully bleached with UV light (5 J/cm²). The samples were characterized by spectrometry and with regard to the adhesion between the photopolymer and polycarbonate film (Makrofol DE 1-1, thickness 125 μm). The results are compiled in Table 1.

TABLE 1
Characterization of Examples A-C and 1 with regard to
hologram and adhesion

| | | | | | Adhesion |
|---|---|---|---|---|---|
| | | | | Shift vs. | 0 (very strong) |
| | Lamination | 1-Tₘᵢₙ | λₚₑₐₖ | reference | to |
| Example | temperature | [%] | [nm] | [nm] | 5 (very low) |
| A | 60° C. | 85.5 | 532 | 2.1 | 5 |
| 1 | 100° C. | 84.4 | 533 | 2.8 | 3 |
| B | 120° C. | — | — | — | bubble formation |
| C | 140° C. | — | — | — | bubble formation |

In Inventive Example 1, a low hologram shift (vs. reference sample) was measured, with measurement of moderate adhesion between photopolymer and polycarbonate film. In Noninventive Example A, no improvement in adhesion is found. In Noninventive Examples B and C, the films exhibited significant bubble formation.

### Noninventive Examples D-F, Inventive Example 2

A film piece of size 5 cm×7 cm of the photopolymer film was cut to size in the dark (5×7 cm) and the PE lamination was removed. Subsequently, the photopolymer surface was laminated together with a polycarbonate film (Makrofol DE 1-1, thickness 125 μm) by means of a roll laminator (Dumor Trident 46; lamination speed: 0.3 m/min, roll pressure setting: high) at room temperature. Thereafter, a reflection hologram was written at 532 nm and the sample was laminated once again by means of the roll laminator at various roll temperatures and then fully bleached with UV light (5 J/cm²). The samples were characterized by spectrometry and with regard to adhesion. The results are compiled in Table 2.

TABLE 2
Characterization of Examples D-F and 2 with regard to
hologram and adhesion

| | | | | | Adhesion |
|---|---|---|---|---|---|
| | | | | Shift vs. | 0 (very strong) |
| | Lamination | 1-Tₘᵢₙ | lₚₑₐₖ | reference | to |
| Example | temperature | [%] | [nm] | [nm] | 5 (very low) |
| D | RT | 82.6 | 535 | 4.9 | 5 |
| 2 | 100° C. | 81.4 | 533 | 3.5 | 3 |
| E | 120° C. | — | — | — | bubble formation |
| F | 140° C. | — | — | — | bubble formation |

In Inventive Example 2, moderate adhesion was determined, with measurement of a slight hologram shift (vs. reference sample). In Noninventive Example D no adhesion was found; in Noninventive Examples E and F significant bubble formation was found.

### Noninventive Examples G-I, Inventive Examples 3-6

A film piece of size 5 cm×7 cm of the photopolymer film was cut to size in the dark (5×7 cm) and the PE lamination was removed. Subsequently, the photopolymer surface was laminated together onto glass and a reflection hologram was written at 532 nm. Subsequently, the film was delaminated from the glass and the photopolymer surface was laminated onto a polycarbonate film (Makrofol DE 1-1, thickness 125 μm) by means of a roll laminator (Dumor Trident 46; lamination speed: 0.3 m/min, roll pressure setting: high) at various laminator roll temperatures. This was followed by complete bleaching with UV light (5 J/cm²). The samples were characterized by spectrometry and with regard to adhesion. The results are compiled in Table 3.

TABLE 3
Characterization of Examples G-I and 3-6 with regard to
hologram and adhesion

| | | | | | Adhesion |
|---|---|---|---|---|---|
| | | | | Shift vs. | 0 (very strong) |
| | Lamination | 1-Tₘᵢₙ | λₚₑₐₖ | reference | to |
| Examples | temperature | [%] | [nm] | [nm] | 5 (very low) |
| G | RT | 93.4 | 529 | −1.0 | 5 |
| 3 | 70° C. | 93.5 | 529 | −1.0 | 4 |
| 4 | 80° C. | 93.9 | 529 | −1.0 | 3-4 |
| 5 | 100° C. | 94.5 | 530 | 0.3 | 3 |
| 6 | 110° C. | 94.7 | 530 | 0.3 | 2 |
| H | 120° C. | — | — | — | bubble formation |
| I | 140° C. | — | — | — | bubble formation |

In Inventive Examples 3 to 6, a small hologram shift (vs. reference sample) was measured, while there was a distinct rise in the adhesion between the photopolymer and polycarbonate film with temperature. In Noninventive Example G, no adhesion is observed. In Noninventive Examples H and I, the films exhibited significant bubble formation.

### Noninventive Example L, Inventive Examples 7-12

A film piece of size 5 cm×7 cm of the photopolymer film was cut to size in the dark (5×7 cm) and the PE lamination was removed. Subsequently, the photopolymer surface was laminated together onto glass and a reflection hologram was written at 532 nm. Subsequently, the film was delaminated from the glass and the photopolymer surface was laminated with a polycarbonate film (Makrofol DE 1-1, thickness 125 μm) by means of a roll laminator (Dumor Trident 46; lamination speed: 0.3 m/min, roll pressure setting: high) at room temperature. This was followed by heat treatment of the construction at various temperatures in the oven. The samples were exposed by UV light treatment (5 J/cm²) directly after the heating in the oven. Finally, the samples were characterized by spectrometry and with regard to adhesion. The results and the experimental parameters are summarized in Table 4.

TABLE 4
Characterization of Inventive Examples 7-12 and Noninventive
Example L with regard to hologram stability and adhesion

| | | Storage | Time | | | | Adhesion |
|---|---|---|---|---|---|---|---|
| | | time in | between | | | | 0 (very |
| | Oven | the | oven | | | Shift vs. | strong) |
| | temp. | oven | and UV | 1-Tₘᵢₙ | λₚₑₐₖ | reference | to 5 |
| Example | (° C.) | (sec.) | step min | [%] | [nm] | [nm] | (very low) |
| 7 | 100 | 20 | 5 min | 93.3 | 527 | −3.4 | 4 |
| 8 | 100 | 30 | 5 min | 96.2 | 529 | −1.3 | 4 |
| 9 | 100 | 50 | 5 min | 96.4 | 528 | −1.7 | 3 |
| 10 | 100 | 70 | 5 min | 95.3 | 529 | −0.6 | 3 |
| 11 | 100 | 90 | 5 min | 95.5 | 528 | −2.4 | 2 |
| 12 | 100 | 120 | 5 min | 95.9 | 529 | −1.0 | 2 |
| L | 120 | 30 | 5 min | — | — | — | bubble |
| | | | | | | | formation |

In Inventive Examples 7 to 12, a small, acceptable hologram shift was measured, while there was a rise in the adhesion between the photopolymer and polycarbonate film with temperature. In Noninventive Example L, significant bubble formation was observed. Examples 9-12 are preferred (storage time>50 seconds at oven temperature 100° C.), and Examples 11-12 (storage time>90 seconds at oven temperature 100° C.) are particularly preferred.

### Noninventive Examples M-S, Inventive Examples 13-15

A film piece of size 5 cm×7 cm of photopolymer film was cut to size in the dark (5×7 cm) and the PE lamination was removed. Subsequently, the photopolymer surface was laminated together onto various thermoplastic polymer films by means of a roll laminator (Dumor Trident 46; lamination speed: 0.3 m/min, roll pressure setting: high) at room temperature. Subsequently, the construction was subjected to heat treatment in the oven at 100° C. for 20 seconds. Details of the experiments and the results are collated in Table 5.

TABLE 5
Adhesion between photopolymer layer and various laminated-on
thermoplastic polymer films and glass

| | | | Adhesion |
|---|---|---|---|
| | | | 0 (very strong) |
| | Laminated-on | Material of the | to |
| Example | polymer films | substrate film | 5 (very low) |
| 13 | Bayfol OX503 66 μm | BP A polycarbonate | 2 |
| 14 | Makrofol 1-1 125 μm | BP A polycarbonate | 2 |
| M | Transphan 60 μm | Polyamide | 5 |
| N | Tacphan 50 μm | Cellulose triacetate | 5 |
| 15 | Pokalon 60 μm | BP TMC polycarbonate | 2-3 |
| O | Hostaphan 36 μm | Polyethylene glycol | 5 |
| | | terephthalate | |
| P | Hostaphan 23 μm | Polyethylene glycol | 5 |
| | | terephthalate | |
| Q | Hostaphan 50 μm | Polyethylene glycol | 5 |
| | | terephthalate | |
| R | Plexiglas 1.5 mm | Polymethylmethacrylat | 5 |
| S | Glass | Soda glass | 5 |

Good adhesion was generated only in Inventive Examples 13, 14 and 15 with PC-based films. In Noninventive Examples M to S with non-polycarbonate-based materials, adhesion after processing remains low.

### Noninventive Example T, Inventive Examples 16-19

A film piece of size 15 cm×20 cm of a photopolymer film with thickness 25 μm was cut to size in the dark (15×20 cm) and the PE lamination was removed. Subsequently, the photopolymer surface was laminated together on a polycarbonate film (Makrofol DE 1-1, thickness 125 μm) (Dumor Trident 46; lamination speed: 0.3 m/min, roll pressure setting: high) at room temperature. This was followed by heat treatment of the construction with various temperatures and times in the oven. Subsequently, the samples were fully bleached with UV light (5 J/cm²). Each film was cut into at least 6 different strips of width 10 mm. The bonding forces between the photopolymer and polycarbonate film were measured in accordance with ISO/IEC 10373 with a tensile tester according to DIN EN ISO 527-1. Details of the experiments and the results are collated in Table 6. The bonding force figures in the table correspond to the mean from six individual measurements on identically prepared samples.

TABLE 6
Bonding forces (in N/10 mm) measured between photopolymer layer
B and laminated-on polycarbonate film (substrate layer C)

| | | | | | Adhesion |
|---|---|---|---|---|---|
| | | Thermal | | Bonding | 0 (very strong) |
| | Oven temp. | treatment | | force | to |
| Examples | (° C.) | time | | [N/10 mm] | 5 (very low) |
| T | 60 | 5 | min | 0.3 | 5 |
| 16 | 70 | 30 | sec | 1.3 | 3 |
| 17 | 100 | 30 | sec | 4.8 | 1 |
| 18 | 100 | 10 | min | 13.0 | 0 |
| 19 | 110 | 30 | sec | 4.6 | 1 |

In Inventive Examples 17 to 19, a very good bonding force was obtained, and this rose as a function of oven temperature and time. In Example 19, a very high bonding force of 13 N/10 mm was obtained, and so the layer construction can no longer be separated without destruction.

### Inventive Examples 20 and 21

A film piece of size 15 cm×20 cm of photopolymer film in thickness 15 μm was cut to size in the dark (15×20 cm) and the PE lamination was removed. Subsequently, the photopolymer surface was laminated onto glass and reflection holograms were written with variable writing dose at 532 nm. Subsequently, the latter were delaminated from the glass in the dark and laminated onto a polycarbonate film (Makrofol DE 1-1, thickness 125 μm) (Dumor Trident 46; lamination speed: 0.3 m/min, roll pressure setting: high) at room temperature. This was followed by heat treatment in the oven at 100° C. for 20 seconds. Subsequently, the samples were fully bleached with UV light (5 J/cm²). Each film was cut into 6 different strips of width 10 mm. The bonding forces between the photopolymer and polycarbonate film were measured in accordance with ISO/IEC 10373 with a tensile tester according to DIN EN ISO 527-1. Details of the experiments and the results are collated in Table 7.

TABLE 7
Bonding forces (in N/10 mm) measured between photopolymer
layer B and laminated-on PC film (substrate layer C)

| | | | Adhesion |
|---|---|---|---|
| | Writing | Bonding | 0 (very strong) |
| | dose | force | to |
| Examples | (mJ/cm²) | [N/10 mm] | 5 (very low) |
| 20 | 29.6 | 3.5 | 3 |
| 21 | 177.8 | 3.5 | 3 |

1.-15. (canceled)

16. A process for producing an at least part-bonded layer construction comprising a photopolymer layer B containing a hologram, and a substrate layer C of (co)polycarbonate, wherein the process comprises the following steps:
a) directly contacting an unexposed photopolymer layer B or a part-exposed photopolymer layer B containing a hologram with the substrate layer C, so as to form a layer composite B-C,
b) heating the layer composite B-C to a temperature of 70° C. to 110° C.,
c) optionally exposing a hologram into the unexposed photopolymer layer B comprising matrix polymers, writing monomers, photoinitiators, optionally at least one non-photopolymerizable component and optionally catalysts, free-radical stabilizers, solvents, additives and other assistants and/or added substances,
d) subjecting the part-exposed layer composite B-C containing a hologram to actinic radiation,
wherein step d) is always conducted as the last step.

17. The process according to claim 16, wherein process steps a)-d) are conducted in the sequence a), b), c) and d) or in the sequence a), c), b) and d) or in the sequence c), a), b) and d).

18. The process according to claim 16, wherein the layer composite B-C is heated in step b) for 0.2 second to 60 minutes.

19. The process according to claim 16, wherein the layer composite after step b) has a bonding force in accordance with ISO/IEC 10373 using a tensile tester according to DIN EN ISO 527-1 between the photopolymer layer B and the substrate layer C of at least 0.5 N/10 mm.

20. The process according to claim 16, wherein the temperature in step b) is 75° C. to 110° C.

21. The process according to claim 16, wherein step b) is conducted in a heated space, or by means of a laminator.

22. The process according to claim 16, wherein step a) and step b) are conducted in a joint step.

23. The process according to claim 16, wherein the photopolymer layer B is present on a substrate layer A, and where the layers A and B are bonded to one another in an adhesive-free manner.

24. The process according to claim 16, wherein the substrate layer C is present on a substrate layer D and is at least part-bonded thereto, and where the substrate layer D consists of a transparent thermoplastic material or a material composite.

25. The process according to claim 16, wherein the glass transition temperature T_{g} of the substrate layer C is higher than the temperature in process steps a)-d) for production of the layer composite B-C.

26. The process according to claim 16, wherein the substrate layer C is an aromatic polycarbonate layer.

27. A layer construction comprising a photopolymer layer B containing a hologram and a substrate layer C of (co)polycarbonate, obtained by the process of claim 16.

28. A sealed holographic medium comprising a layer construction according to claim 27.

29. An optical display comprising a sealed holographic medium according to claim 28, wherein the optical display is selected from the group consisting of autostereoscopic or holographic displays, projection screens, displays with switchable restricted emission characteristics for privacy filters and bidirectional multiuser screens, virtual displays, head-up displays, head-mounted displays, illumination symbols, warning lamps, signal lamps, floodlights/headlights, and display panels.

30. A security document comprising a sealed holographic medium according to claim 29.
